(19) United States
(12) Patent Application Publication
(10) Pub. No.: US 2026/0077634 A1
(43) Pub. Date: Mar. 19, 2026

(54) DEPLOYABLE GLASS GUARD SYSTEMS FOR MOTOR VEHICLES

(71) Applicant: FORD GLOBAL TECHNOLOGIES, LLC, Dearborn, MI (US)

(72) Inventors: Stuart C. Salter, White Lake, MI (US); Christine Park Cheng, Birmingham, MI (US); Michael J. Kipley, Saline, MI (US); Vince A. Chimento, Plymouth, MI (US); Michael John Harmon, Northville, MI (US); Cliff Standifer, Canton, MI (US)

(21) Appl. No.: 18/887,299

(22) Filed: Sep. 17, 2024

(51) Int. Cl. B60J 1/20

(52) U.S. Cl. CPC B60J 1/2094

(57) ABSTRACT

Deployable glass guard systems are provided for motor vehicles. An exemplary deployable glass guard system may include a deployable glass guard that is moveable between a stowed position and a deployed position relative to a window of the vehicle. In the deployed position, the deployable glass guard is positioned to protect a glass panel of the window. The deployable glass guard system may be a manually actuated system or a powered system. In some implementations, the deployable glass guard system may be an accessory system of the vehicle.

### TECHNICAL FIELD

This disclosure relates generally to motor vehicles, and more particularly to deployable glass guard systems for protecting glass panels of motor vehicles.

### BACKGROUND

Many motor vehicles include cargo spaces for transporting various types of cargo. A pickup truck, for example, includes a cargo bed that establishes the cargo space of the truck.

### SUMMARY

A motor vehicle according to an exemplary aspect of the present disclosure includes, among other things, a window, a bulkhead, and a deployable glass guard movable between a stowed position inside the bulkhead and a deployed position in which the deployable glass guard protects a glass panel of the window.

In a further non-limiting embodiment of the foregoing motor vehicle, the bulkhead establishes a front wall of a cargo bed of the motor vehicle.

In a further non-limiting embodiment of either of the foregoing motor vehicles, the bulkhead establishes both a front wall of a cargo bed and a rear wall of a passenger compartment of the motor vehicle.

In a further non-limiting embodiment of any of the foregoing motor vehicles, the deployable glass guard includes a plurality of openings arranged in a pattern.

In a further non-limiting embodiment of any of the foregoing motor vehicles, the pattern is a grid pattern, a slotted pattern, or a mesh pattern.

In a further non-limiting embodiment of any of the foregoing motor vehicles, the pattern establishes a personized feature within the deployable glass guard.

In a further non-limiting embodiment of any of the foregoing motor vehicles, the deployable glass guard includes an upper lip that includes a cushion that faces toward the window when the deployable glass guard is moved to the deployed position.

In a further non-limiting embodiment of any of the foregoing motor vehicles, the deployable glass guard is received within a pocket of the bulkhead when in the stowed position.

In a further non-limiting embodiment of any of the foregoing motor vehicles, the deployable glass guard is part of a manually operable deployable glass guard system that includes a first guide track, a second guide track, and a latching system.

In a further non-limiting embodiment of any of the foregoing motor vehicles, the first guide track is located within a first outboard side of the bulkhead, and the second guide track is located within a second outboard side of the bulkhead.

In a further non-limiting embodiment of any of the foregoing motor vehicles, a tongue of the deployable glass guard is received within a groove of the first guide track to guide movement of the deployable glass guard between the stowed position and the deployed position.

In a further non-limiting embodiment of any of the foregoing motor vehicles, the latching system includes a release lever, a link, a pinion, and a pin.

In a further non-limiting embodiment of any of the foregoing motor vehicles, the pin engages a lower notch of the first guide track when the deployable glass guard is located in the stowed position and engages an upper notch of the first guide track when the deployable glass guard is in the deployed position.

In a further non-limiting embodiment of any of the foregoing motor vehicles, a compression spring biases the pin into engagement with the lower notch when the deployable glass guard is located in the stowed position.

In a further non-limiting embodiment of any of the foregoing motor vehicles, the deployable glass guard is part of a powered deployable glass guard system that includes a guide track and a powered deployment system.

In a further non-limiting embodiment of any of the foregoing motor vehicles, the guide track includes a first guide track and a second guide track that cooperate to guide movement of the deployable glass guard between the stowed position and the deployed position.

In a further non-limiting embodiment of any of the foregoing motor vehicles, the guide track includes an upper channel that connects between the first guide track and the second guide track. Th e upper channel is configured to receive the deployable glass guard when in the deployed position.

In a further non-limiting embodiment of any of the foregoing motor vehicles, the powered deployment system includes a regulator cartridge, a pair of upper pulleys, a pair of lower pulleys, a pair of drive cables, and a pair of regulator motors.

In a further non-limiting embodiment of any of the foregoing motor vehicles, the deployable glass guard and each of the pair of upper pulleys, the pair of lower pulleys, and the pair of regulator motors are mounted relative to the regulator cartridge.

A motor vehicle according to another exemplary aspect of the present disclosure includes, among other things, a passenger compartment, a cargo bed rearward of the passenger compartment, and a deployable glass guard system securable to the cargo bed and configured to transition between a first configuration and a second configuration. In the first configuration, the deployable glass guard system functions as a bed cover of the cargo bed. In the second configuration, the deployable glass guard system functions as a glass guard for protecting a window of the passenger compartment.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a rear perspective view of a motor vehicle equipped with a deployable glass guard positioned in a stowed position.

FIG. 2 is a rear perspective view of the vehicle of FIG. 1 with the deployable glass guard positioned in a deployed position.

FIG. 3 is a side view of FIG. 2 with the deployable glass guard positioned in the deployed position.

FIG. 4 illustrates the deployable glass guard of FIG. 3 in a flexed position as the result a force imparted by shifting cargo.

FIG. 5 illustrates another exemplary deployable glass guard.

FIG. 6 illustrates another exemplary deployable glass guard.

FIG. 7 illustrates yet another exemplary deployable glass guard.

FIG. 8 illustrates aspects of a deployable glass guard system that includes a deployable glass guard.

FIG. 9 illustrates an interface between a deployable glass guard and a guide track of the deployable glass guard system of FIG. 8.

FIGS. 10, 11, and 12 illustrate a latching system of a deployable glass guard system.

FIG. 13 illustrates a release lever of a deployable glass guard system.

FIGS. 14, 15, 16, 17, and 18 illustrate another exemplary deployable glass guard system.

FIGS. 19, 20, and 21 illustrate another exemplary deployable glass guard system.

FIGS. 22, 23, and 24 illustrate another exemplary deployable glass guard system.

### DETAILED DESCRIPTION

This disclosure details deployable glass guard systems for motor vehicles. An exemplary deployable glass guard system may include a deployable glass guard that is moveable between a stowed position and a deployed position relative to a window of the vehicle. In the deployed position, the deployable glass guard is positioned to protect a glass panel of the window. The deployable glass guard system may be a manually actuated system or a powered system. In some implementations, the deployable glass guard system may be an accessory system of the vehicle. These and other features of this disclosure are described in greater detail below.

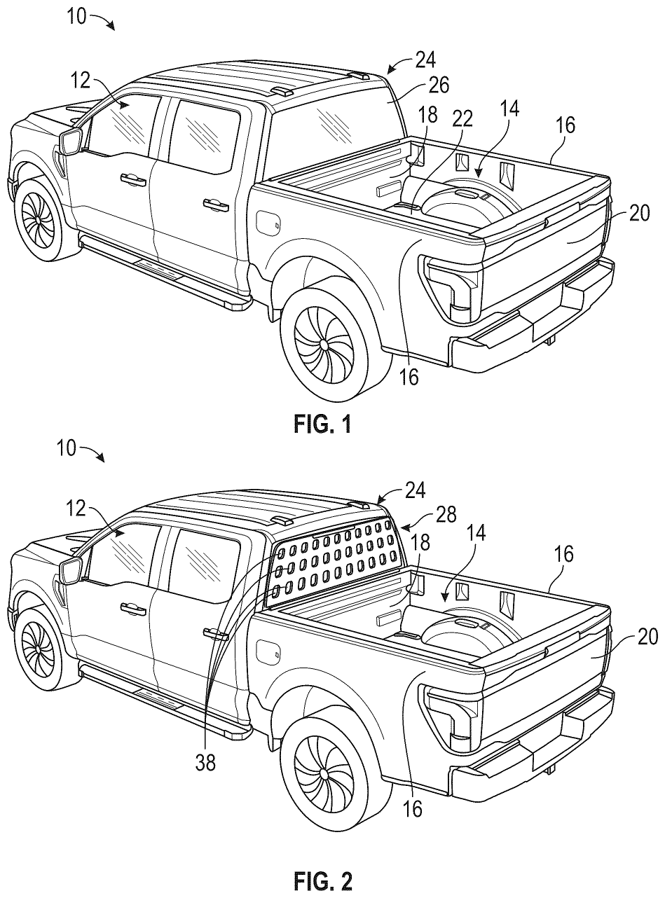

FIGS. 1, 2, 3, and 4 illustrate a motor vehicle 10 that includes a passenger compartment 12 and a cargo bed 14 located rearward of the passenger compartment 12. The vehicle 10 could be a conventional, internal combustion engine powered vehicle, a hybrid or plug-in hybrid vehicle, a battery electric vehicle, an autonomous vehicle (i.e., a driverless vehicle), etc.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the vehicle 10 is a pickup truck, and therefore the cargo bed 14 establishes a rear cargo space of the pickup truck. The cargo bed 14 may generally be defined by side walls 16, a bulkhead 18 that establishes a front wall of the cargo bed 14, a tailgate 20 that, when closed, establishes a rear wall of the cargo bed 14, and a floor 22 that establishes a base of the cargo bed 14. However, other vehicle configurations are also contemplated within the scope of this disclosure.

A cab back 24 closes off and thus separates the passenger compartment 12 from the rear cargo space of the cargo bed 14. The cab back 24 may include a rear window 26 that allows passengers to view the rear cargo space of the cargo bed 14 from the inside of the passenger compartment 12. The rear window 26 may include a glass panel that is sometimes referred to as the “back glass” of the passenger compartment 12. In an embodiment, such as when the vehicle 10 includes a body-on-frame construction, the bulkhead 18 is a completely separate structure from the cab back 24. In another embodiment, such as when the vehicle 10 includes a unibody construction, the bulkhead 18 may be integrated as part of the cab back 24.

The vehicle 10 may additionally include a deployable glass guard 28 that is movable between a stowed position (see FIG. 1) and a deployed position (see FIGS. 2-4). In the stowed position, the deployable glass guard 28 is housed inside the bulkhead 18. The view through the rear window 26 is unobstructed when the deployable glass guard 28 is in the stowed position.

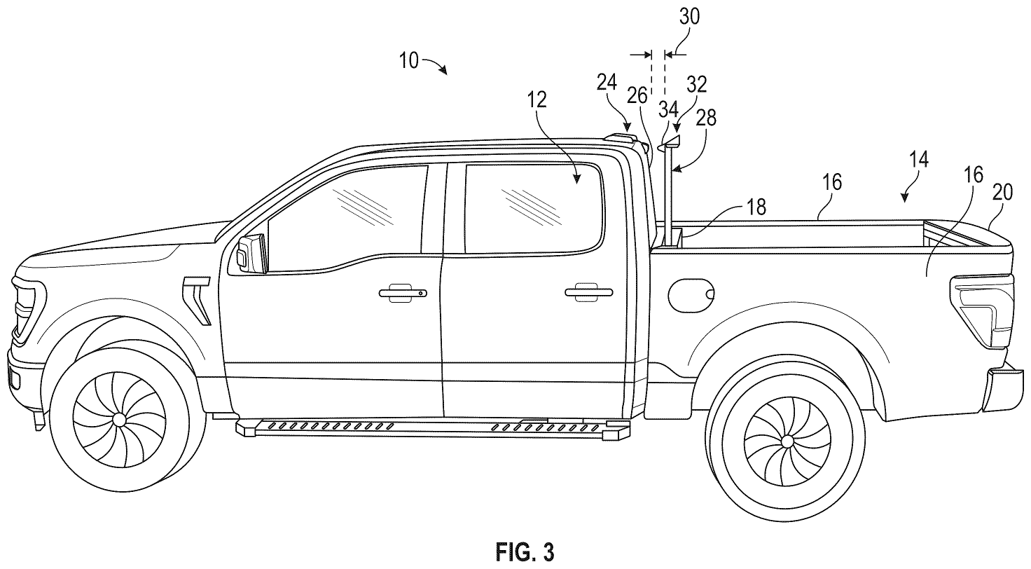

In the deployed position, the deployable glass guard 28 is directly in front (when viewed from the cargo bed 14) of the rear window 26 for protecting the rear window 26. The deployed position is therefore a vertically raised position relative to the stowed position. Vertical, for the purposes of this disclosure, is with reference to ground in an ordinary orientation of the vehicle 10. A gap 30 (see FIG. 3) may extend between the rear window 26 and the deployable glass guard 28 when the deployable glass guard 28 is in the deployed position.

The deployable glass guard 28 may be made of a thermoplastic material. In an embodiment, the deployable glass guard 28 is made of acrylonitrile butadiene styrene (ABS). In another embodiment, the ABS used to manufacture the deployable glass guard 28 may include fillers such as fiberglass or carbon fibers for increasing the structural stiffness and strength of the deployable glass guard 28. In yet another embodiment, the deployable glass guard 28 is made of a combination of ABS and polycarbonate. However, other materials or combinations of materials could be utilized to construct the deployable glass guard 28 within the scope of this disclosure.

The deployable glass guard 28 may include an upper lip 32. The upper lip 32 may be configured to seal an opening of the bulkhead 18 when the deployable glass guard 28 is moved to the stowed position.

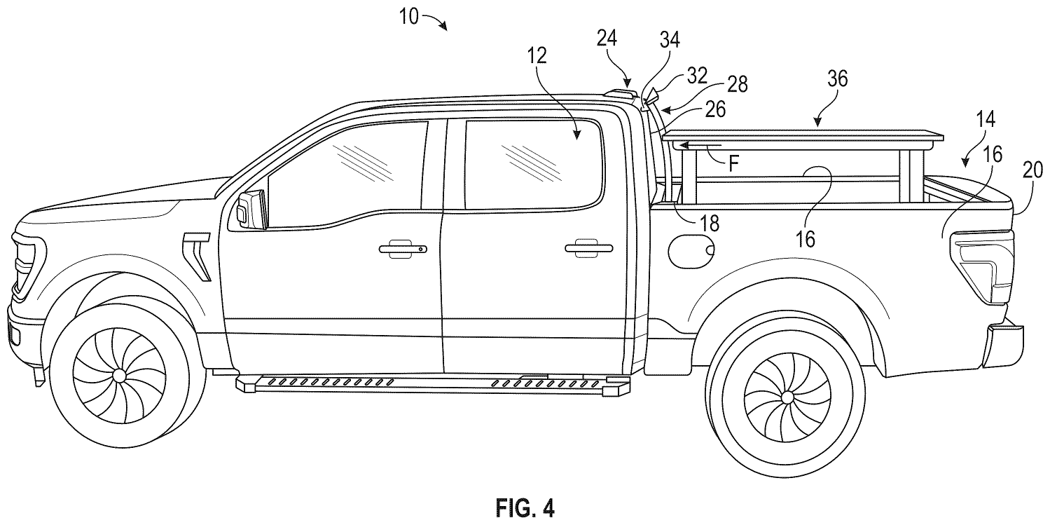

In some situations, the deployable glass guard 28 may flex in a direction toward the rear window 26, such as when an item of cargo 36 being hauled within the cargo bed 14 shifts forward and applies a force F (see FIG. 4) to a rear-facing side of the deployable glass guard 28, for example. The upper lip 32 of the deployable glass guard 28 may include a cushion 34 for softening any contact between the deployable glass guard 28 and the rear window 26 as a result of the force F. In an embodiment, the cushion 34 is a rubber component. However, other materials could be utilized within the scope of this disclosure.

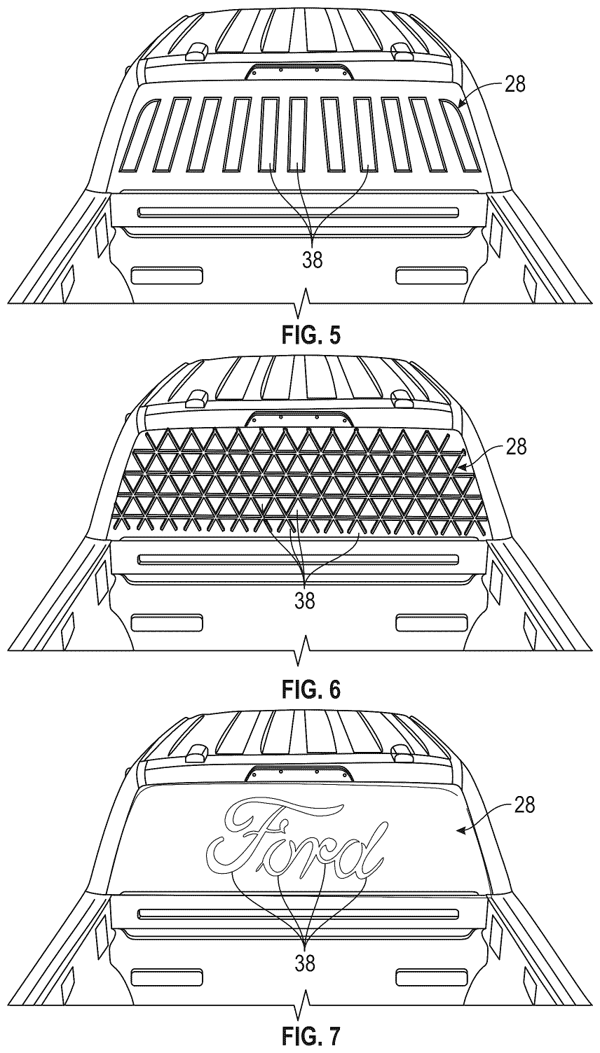

A plurality of openings 38 (see FIG. 2) may be formed through the deployable glass guard 28. The openings 38 allow users to see through the deployable glass guard 28 even when it is raised to the deployed position. The openings 38 may be arranged in various patterns or configurations. For example, the openings 38 may be arranged in a grid pattern (see, e.g., FIG. 2), a slotted pattern (see, e.g., FIG. 5), or a mesh pattern (see, e.g., FIG. 6). In other implementations, the openings 38 may be arranged together to provide a personized feature within the deployable glass guard 28 (see, e.g., FIG. 7). For example, the personalized feature could include a brand name, a user's initials, a logo or symbol, a phrase, etc. Other configurations of the openings 38 beyond those specifically illustrated in FIGS. 2 and 5-7 could also be possible and are thus further contemplated within the scope of this disclosure.

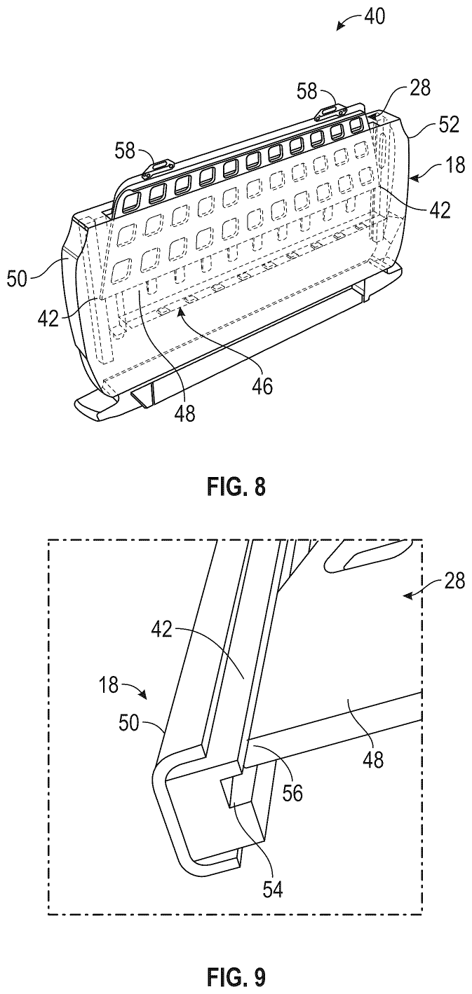

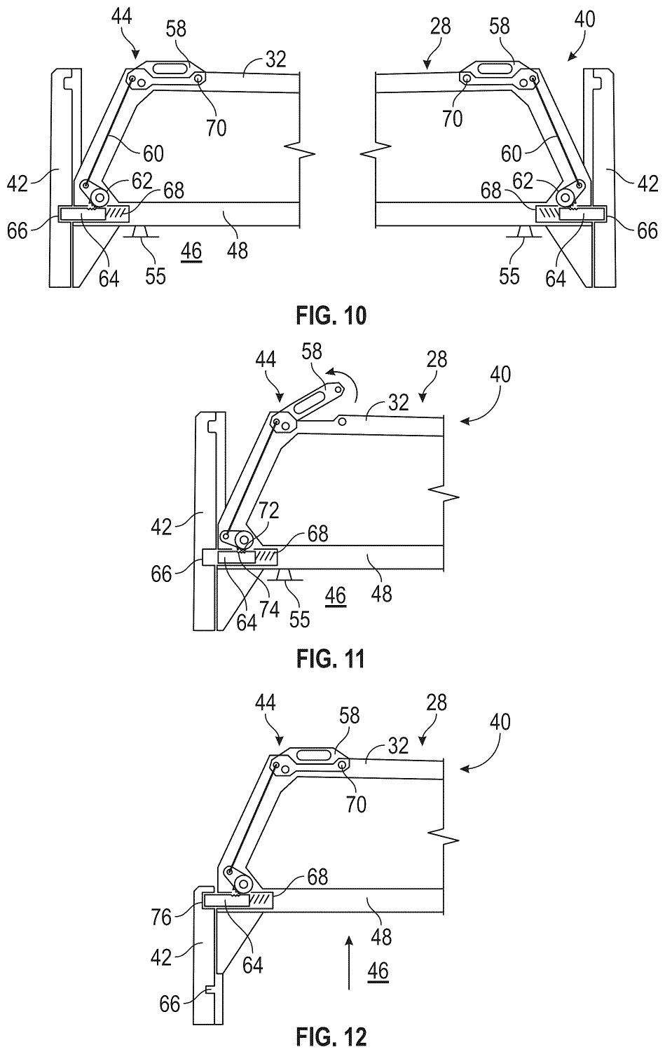

Referring now to FIGS. 8-12, with continued reference to FIGS. 1-4, the deployable glass guard 28 may be part of a deployable glass guard system 40 that includes the bulkhead 18, a pair of guide tracks 42, and a latching system 44 (best shown in FIGS. 10-12). The bulkhead 18 may include a pocket 46 that is sized to receive the deployable glass guard 28. The pocket 46 extends inside the bulkhead 18. In the stowed position, an entirety of the deployable glass guard 28 is received within the pocket 46. In the deployed position, a majority of the deployable glass guard 28 is raised to position that extends outside of the pocket 46. In an embodiment, only a base section 48 of the deployable glass guard 28 remains inside the pocket 46 when the deployable glass guard 28 has been moved to the deployed position.

The guide tracks 42 may be positioned within the bulkhead 18 for guiding movement of the deployable glass guard 28 between the stowed and deployed positions. One guide track 42 may extend inside a first outboard side 50 of the bulkhead 18, and the other guide track 42 may extend inside a second outboard side 52 of the bulkhead 18. In an embodiment, the guide tracks 42 are integrated features formed within the interior of the bulkhead 18. In another embodiment, the guide tracks 42 are separate components that are mounted within the interior the bulkhead 18.

Each guide track 42 may include a groove 54 (see FIG. 9) that extends across an entire length of the guide track 42. A tongue 56 (see FIG. 9) of the base section 48 of the deployable glass guard 28 may be received within the groove 54 for establishing a tongue-and-groove connection at each opposing side of the deployable glass guard 28. The tongue-and-groove connection provides a relatively smooth, gliding movement of the deployable glass guard 28 between the stowed and deployed positions.

Referring now primarily to FIGS. 10-12, the latching system 44 may be configured to allow one or more users to manually move the deployable glass guard 28 from the stowed position to the deployed position and subsequently return the deployable glass guard 28 from the deployed position to the stowed position. The latching system 44 may include one or more release levers 58, links 60, pinions 62, and pins 64.

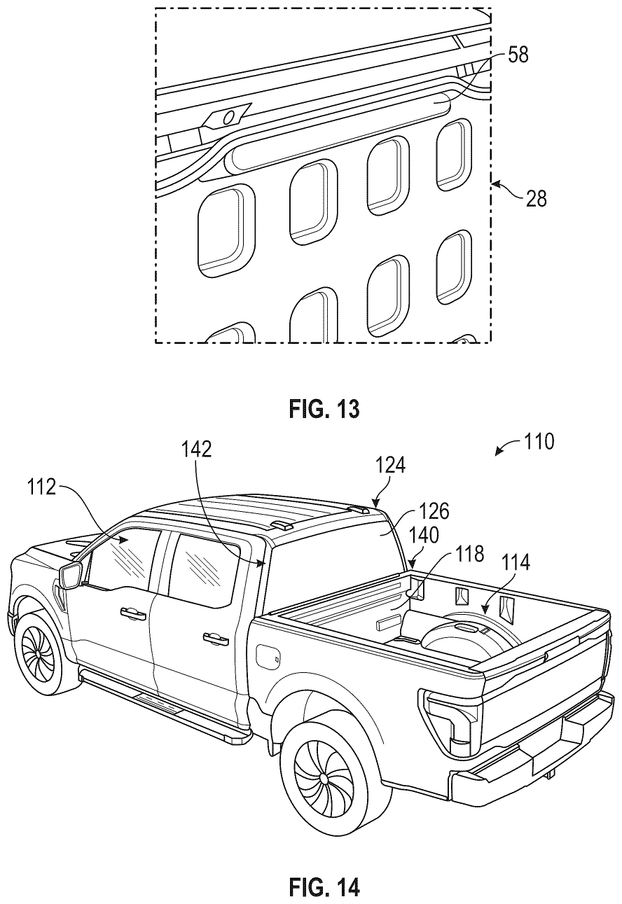

In an embodiment, the latching system 44 includes two release levers 58, with one release lever 58 being provided near each opposing end of the upper lip 32 of the deployable glass guard 28 (see FIG. 10). In such an implementation, a single user can manually move the deployable glass guard 28 when standing at or a near the center of the cargo bed 14, or two users can manually move the deployable glass guard 28 by positioning one user outside of each side wall 16 of the cargo bed 14. In another embodiment, the latching system 44 includes a single release lever 58 (see FIG. 13) that can be actuated by a single user to manually move the deployable glass guard 28.

An exemplary methodology for manually raising the deployable glass guard 28 from the stowed position to the deployed position will now be described. In some instances, the figures illustrate the various latching/unlatching operations relative to a left hand side of the deployable glass guard system 40. As would be appreciated by a person of ordinary skill in the art having the benefit of this disclosure, similar latching/unlatching operations would simultaneously occur at the right hand side of the deployable glass guard system 40.

The deployable glass guard 28 is shown in the stowed position and the latching system 44 is shown in a first latched position in FIG. 10. In this position, the pin 64 of the latching system 44 is accommodated within a lower notch 66 formed in one of the guide tracks 42. The deployable glass guard 28 cannot be raised to the vertical position when the pin 64 is engaged to the lower notch 66. A compression spring 68 of the latching system 44 may bias the pin 64 into engagement with the lower notch 66. A bumper stop 55 may delimit the distance the deployable glass guard 28 extends inside the pocket 46.

The latching system 44 is shown in an unlatched position in FIG. 11. In this position, the pin 64 of the latching system 44 has been moved to a disengaged position relative to the lower notch 66. For example, a user may transition the latching system 44 to the unlatched position by releasing and then rotating the release lever 58 relative to the upper lip 32. The release lever 58 may be releasably connected to the deployable glass guard 28 by a secondary latch 70 of the latching system 44.

Rotation of the release lever 58 moves the link 60 distally, thereby causing the pinion 62 to rotate (here, in a counterclockwise direction for the left hand side pinion 62). The pinion 62 may include teeth 72 that are configured to mesh with corresponding teeth 74 of the pin 64. Rotation of the pinion 62 pulls the pin 64 inward from the lower notch 66 by overcoming the biasing force of the compression spring 68. The deployable glass guard 28 is free to be manually raised to the deployed position once the pin 64 is disengaged from the lower notch 66.

The deployable glass guard 28 is shown in the deployed position and the latching system 44 is shown in a second latched position in FIG. 12. In this position, the deployable glass guard 28 is in the raised position for protecting the rear window 26 from shifting cargo, for example. When the deployable glass guard 28 has been fully raised, the compression spring 68 may force the pin 64 outward into engagement with an upper notch 76 formed in the guide track 42. The release lever 58 may then be rotated back to its non-actuated position relative to the upper lip 32. The secondary latch 70 may lock the release lever 58 in the non-actuated position until a user subsequently re-actuates the secondary latch 70 for returning the deployable glass guard 28 back to the stowed position.

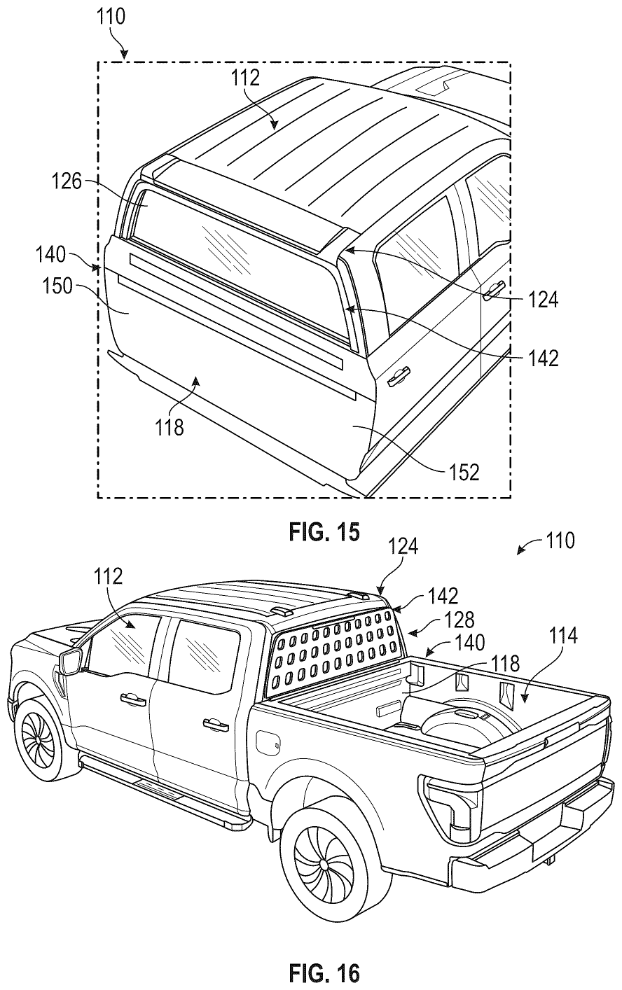

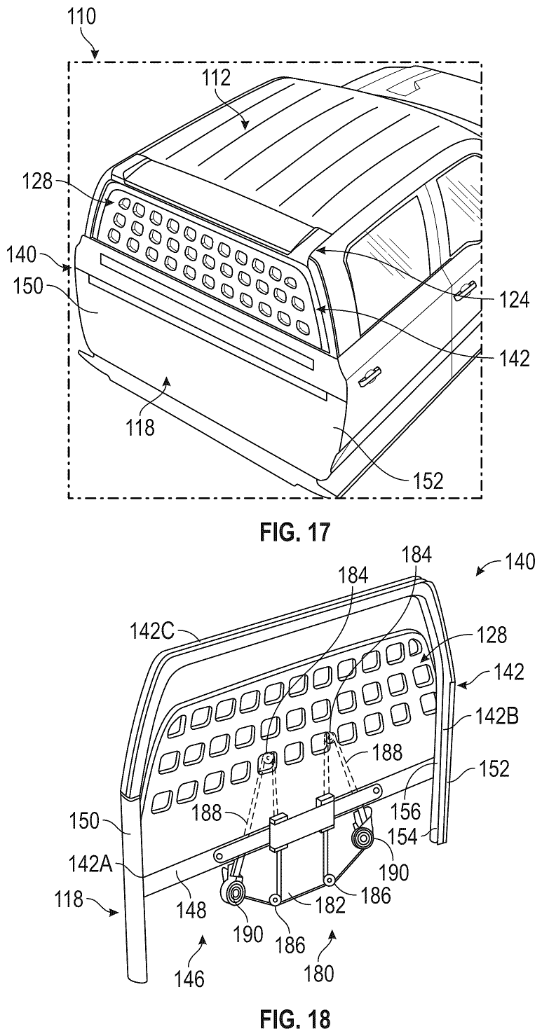

FIGS. 14-18 illustrate another exemplary deployable glass guard system 140 for a motor vehicle 110. The deployable glass guard system 140 may include a bulkhead 118, a deployable glass guard 128, a guide track 142, and a powered deployment system 180 (best shown in FIG. 18). The deployable glass guard 128 is shown in a stowed position in FIGS. 14-15 and in a deployed position in FIGS. 16-17. In the deployed position, the deployable glass guard 128 protects a glass panel of a rear window 126 of the vehicle 110, such as from being directly contacted by shifting cargo being carried within a cargo bed 114 of the vehicle 110.

In this embodiment, the bulkhead 118 and the rear window 126 are incorporated as integrated components of a cab back 124 of the vehicle 110. The bulkhead 118 may therefore provide both a front wall of the cargo bed 114 and a rear wall of a passenger compartment 112 of the vehicle 110.

The bulkhead 118 may include a pocket 146 (see FIG. 18) that is sized to receive the deployable glass guard 128. The pocket 146 extends inside the bulkhead 118. In the stowed position, an entirety of the deployable glass guard 128 is received within the pocket 146. In the deployed position, a majority of the deployable glass guard 128 is raised to position that extends outside of the pocket 146. In an embodiment, only a base section 148 of the deployable glass guard 128 remains inside the pocket 146 when the deployable glass guard 128 is moved to the deployed position.

The guide track 142 may guide the movement of the deployable glass guard 128 between the stowed and deployed positions. The guide track 142 may include a first guide track 142A, a second guide track 142B, and an upper channel 142C that connects between the first guide track 142A and the second guide track 142B. The first and second guide tracks 142A, 142B may be positioned within the bulkhead 118 for guiding movement of the deployable glass guard 128, and the upper channel 142C may extend outside of the bulkhead 118 and be positioned immediately rearward of the rear window 126 for accommodating the deployable glass guard 128 when raised to the deployed position.

The first guide track 142A may extend inside a first outboard side 150 of the bulkhead 118, and the second guide track 142B may extend inside a second outboard side 152 of the bulkhead 118. In an embodiment, the first guide track 142A, the second guide track 142B, and the upper channel 142C establish a unitary, single-piece structure of the guide track 142 of the deployable glass guard system 140.

The first guide track 142A and the second guide track 142B may each include a groove 154 (see FIG. 18). A tongue 156 (see FIG. 18) of the base section 148 of the deployable glass guard 28 may be received within the groove 154 for establishing a tongue-and-groove connection at each side of the deployable glass guard 128. The tongue-and-groove connections provide a relatively smooth, gliding movement of the deployable glass guard 128 between the stowed and deployed positions.

The powered deployment system 180 may function to raise and lower the deployable glass guard 128 between the stowed and deployed positions. As best shown in FIG. 18, for example, the powered deployment system 180 may include a regulator cartridge 182, a pair of upper pulleys 184 (e.g., one on each side of the regulator cartridge 182), a pair of lower pulleys 186 (e.g., one on each side of the regulator cartridge 182), a pair of drive cables 188 (e.g., one for each set of upper and lower pulleys 184, 186), and a pair of regulator motors 190 (e.g., one to drive each drive cable 188).

Each of the regulator cartridge 182, the upper pulleys 184, the lower pulleys 186, the drive cables 188, and the regulator motors 190 may be mounted inside the bulkhead 118. The deployable glass guard 128 and each of the upper pulleys 184, the lower pulleys 186, the drive cables 188, and the regulator motors 190 may be mounted to the regulator cartridge 182. The regulator cartridge 182 can therefore function to establish an interface between the deployable glass guard 128 and the powered deployment system 180.

The powered deployment system 180 may be actuated in response to a user input. For example, the user may push a button located inside the passenger compartment 112 or on a smart device (e.g., smart phone) that is equipped to communicate with the vehicle 110 through a software application. When actuated by the user, the regulator motors 190 drive the drive cables 188 to effectuate the raising or lowering of the deployable glass guard 128 relative to the pocket 146.

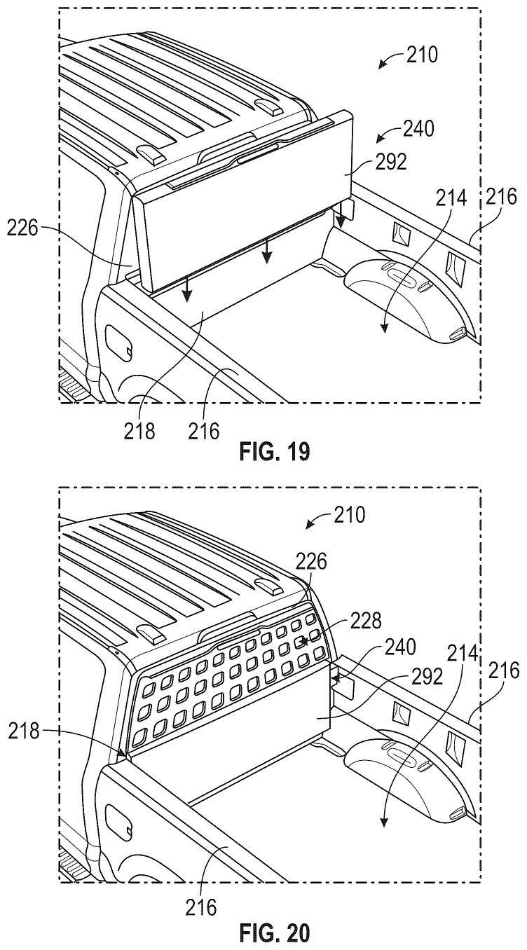

FIGS. 19-21 illustrate another exemplary deployable glass guard system 240 for a motor vehicle 210. In this implementation, the deployable glass guard system 240 may be configured as a drop-in accessory of the vehicle 210.

The deployable glass guard system 240 may include a housing 292 and a deployable glass guard 228 movably received within a pocket 246 of the housing 292. Although not specifically shown in FIGS. 19-21, guide tracks and a latching system similar to those shown in FIGS. 8-12 may be provided inside the housing 292 for guiding movement of the deployable glass guard 228 between stowed and deployed positions.

The housing 292 of the deployable glass guard system 240 may be removably positioned within a cargo bed 214 of the vehicle 210 at a location that is slightly rearward of a bulkhead 218 of the cargo bed 214. In an embodiment, the housing 292 may be releasably secured to side walls 216 of the cargo bed 214.

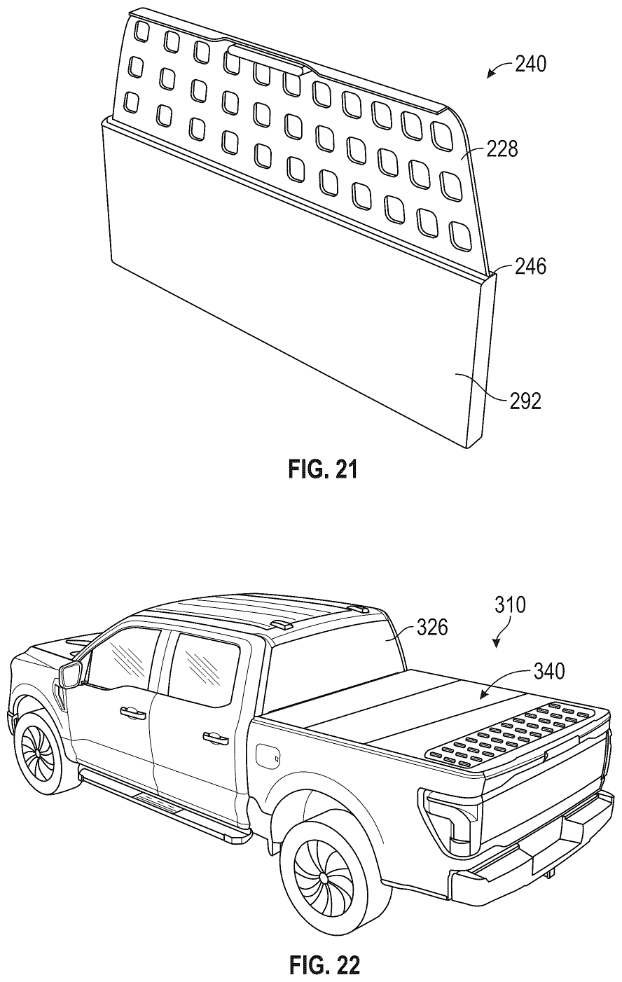

The deployable glass guard 228 is shown in the stowed position in FIG. 19 and in the deployed position in FIGS. 20-21. In the deployed position, the deployable glass guard 228 protects a rear window 226 of the vehicle 110, such as from sliding cargo being hauled within the cargo bed 214.

FIGS. 22-24 illustrate yet another exemplary deployable glass guard system 340 for a motor vehicle 310. In this implementation, the deployable glass guard system 340 may be a multi-functional accessory system that can be attached for use on the vehicle 310.

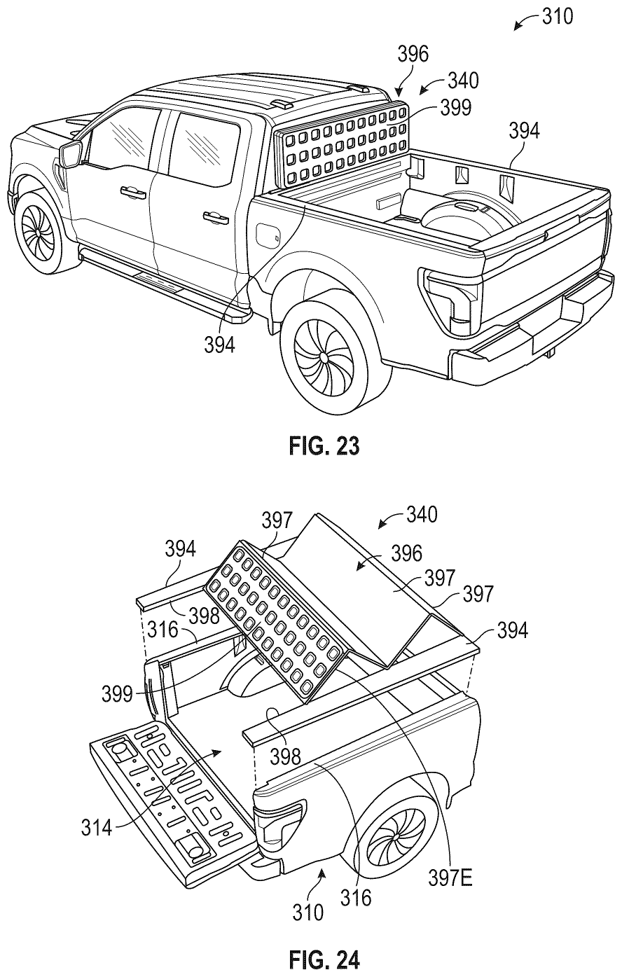

The deployable glass guard system 340 may be configured to transition between a first configuration shown in FIG. 22 and a second configuration shown in FIG. 23. In the first configuration, the deployable glass guard system 340 may function as a bed cover of a cargo bed 314 of the vehicle 310. In the second configuration, the deployable glass guard system 340 may function as a glass guard for protecting a rear window 326 of the vehicle 310.

The deployable glass guard system 340 may include a pair of outer frame members 394 and a panel assembly 396 that is movably secured relative to the outer frame member 394. One outer frame member 394 may be mounted to each side wall 316 of the cargo bed 314 of the vehicle 310. The outer frame members 394 may each include a track 398 for guiding movement of the panel assembly 396.

The panel assembly 396 may include a plurality of panels 397. The panels 397 may be foldably connected to one another to enable an accordion-like motion of the panel assembly 396 for moving between the first and second configurations. An end panel 397E of the panel assembly 396 may include a protective panel 399 that is inlaid into the end panel 397E. When moved to the second configuration, the protective panel 399 faces outward from the panel assembly 396 for providing the glass guard functionality.

The deployable glass guard systems of this disclosure are equipped to provide an integrated solution for protecting a vehicle rear window when hauling cargo. When deployed, the deployable glass guard systems provide back glass peace of mind and protection with a simple and quick transition between positions. When stowed, the deployable glass guard systems allow for a traditional unobstructed view out of the vehicle back glass.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A motor vehicle, comprising:
a window;
a bulkhead; and
a deployable glass guard movable between a stowed position inside the bulkhead and a deployed position in which the deployable glass guard protects a glass panel of the window.

2. The motor vehicle as recited in claim 1, wherein the bulkhead establishes a front wall of a cargo bed of the motor vehicle.

3. The motor vehicle as recited in claim 1, wherein the bulkhead establishes both a front wall of a cargo bed and a rear wall of a passenger compartment of the motor vehicle.

4. The motor vehicle as recited in claim 1, wherein the deployable glass guard includes a plurality of openings arranged in a pattern.

5. The motor vehicle as recited in claim 4, wherein the pattern is a grid pattern, a slotted pattern, or a mesh pattern.

6. The motor vehicle as recited in claim 4, wherein the pattern establishes a personized feature within the deployable glass guard.

7. The motor vehicle as recited in claim 1, wherein the deployable glass guard includes an upper lip that includes a cushion that faces toward the window when the deployable glass guard is moved to the deployed position.

8. The motor vehicle as recited in claim 1, wherein the deployable glass guard is received within a pocket of the bulkhead when in the stowed position.

9. The motor vehicle as recited in claim 1, wherein the deployable glass guard is part of a manually operable deployable glass guard system that includes a first guide track, a second guide track, and a latching system.

10. The motor vehicle as recited in claim 9, wherein the first guide track is located within a first outboard side of the bulkhead, and the second guide track is located within a second outboard side of the bulkhead.

11. The motor vehicle as recited in claim 10, wherein a tongue of the deployable glass guard is received within a groove of the first guide track to guide movement of the deployable glass guard between the stowed position and the deployed position.

12. The motor vehicle as recited in claim 9, wherein the latching system includes a release lever, a link, a pinion, and a pin.

13. The motor vehicle as recited in claim 12, wherein the pin engages a lower notch of the first guide track when the deployable glass guard is located in the stowed position and engages an upper notch of the first guide track when the deployable glass guard is in the deployed position.

14. The motor vehicle as recited in claim 13, comprising a compression spring that biases the pin into engagement with the lower notch when the deployable glass guard is located in the stowed position.

15. The motor vehicle as recited in claim 1, wherein the deployable glass guard is part of a powered deployable glass guard system that includes a guide track and a powered deployment system.

16. The motor vehicle as recited in claim 15, wherein the guide track includes a first guide track and a second guide track that cooperate to guide movement of the deployable glass guard between the stowed position and the deployed position.

17. The motor vehicle as recited in claim 16, wherein the guide track includes an upper channel that connects between the first guide track and the second guide track, the upper channel being configured to receive the deployable glass guard when in the deployed position.

18. The motor vehicle as recited in claim 15, wherein the powered deployment system includes a regulator cartridge, a pair of upper pulleys, a pair of lower pulleys, a pair of drive cables, and a pair of regulator motors.

19. The motor vehicle as recited in claim 18, wherein the deployable glass guard and each of the pair of upper pulleys, the pair of lower pulleys, and the pair of regulator motors are mounted relative to the regulator cartridge.

20. A motor vehicle, comprising:
a passenger compartment;
a cargo bed rearward of the passenger compartment; and
a deployable glass guard system securable to the cargo bed and configured to transition between a first configuration and a second configuration,
wherein, in the first configuration, the deployable glass guard system functions as a bed cover of the cargo bed,
wherein, in the second configuration, the deployable glass guard system functions as a glass guard for protecting a window of the passenger compartment.
